(19) United States
(12) Patent Application Publication
(10) Pub. No.: US 2008/0139830 A1
(43) Pub. Date: Jun. 12, 2008

(54) Preparation of substituted aminoanthraquinones

(75) Inventor: Horst Berneth, Leverkusen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/998,701

(22) Filed: Nov. 30, 2007

(30) Foreign Application Priority Data
Dec. 7, 2006 (DE) 10 2006 057 652.7

(51) Int. Cl. C09B 1/16

(52) U.S. Cl. 552/238

(57) ABSTRACT

Process for preparing substituted aminoanthraquinones by reacting 1,4-di-hydroxyanthraquinone with amines in the presence of dihydro-1,4-dihydroxyanthraquinone and a boric ester.

The invention relates to a process for preparing substituted aminoanthraquinones by reaction of 1,4-dihydroxyanthraquinone with amines in the presence of dihydro-1,4-dihydroxyanthraquinone and a boric ester.

Substituted aminoanthraquinones such as N-substituted 1-amino-4-hydroxyanthraquinones and N,N′-disubstituted 1,4-diaminoanthraquinones and their preparation are known, for example from EP-A-751118 by use of hydroxy carboxylic acid, EP-A-1288192 by use of NMP as a solvent or EP-A-1364993, which utilizes dipolar aprotic solvents. They find utility for example as dyes for plastics and synthetic fibres and also as precursors for preparing wool dyes. Hitherto, they have been prepared by reacting 1,4-dihydroxyanthraquinone (quinizarin) mixed with 2,3-dihydro-1,4-dihydroxyanthraquinone (leucoquinizarin) with amines in the presence or absence of condensation assistants. Examples of such condensation assistants are hydrochloric acid (DE-A 2 342 469), glacial acetic acid (U.S. Pat. No. 4,083,683) or hydroxy carboxylic acids (EP-A-751118). Boric acid is frequently utilized as a catalyst (DE-P 631 518, Zh. Obshch. Khim. 25 (1955) 617 (English translation page 589)). But even with these assistants, the reaction time and the yield are not very good. Foaming is in particular one cause of tardy reaction. There is likewise formation of by-products, of which some are insoluble in the reaction medium, therefore end up in the isolated main product and create problems in use. Other by-products have an adverse influence on the hue and so lead to dull dyeings.

Zh. Organich. Khim. 22 (1986) 611 (English translation page 547) discloses complexes of hydroxyanthraquinone and aminoanthraquinone with boron trifluoride and boron triacetate. They are useful for oxidative introduction of amino groups into previously unsubstituted positions on the anthraquinone.

A process for preparing substituted aminoanthraquinones has now been found that, surprisingly, is characterized by reaction of 1,4-dihydroxyanthraquinone with amines in the presence of dihydro-1,4-dihydroxyanthraquinone and a boric ester.

The process of the invention is preferably useful for preparing N-substituted 1-amino-4-hydroxyanthraquinones and N,N′-disubstituted 1,4-diaminoanthraquinones.

N-Substituted 1-amino-4-hydroxyanthraquinones are preferably those of the formula (II)

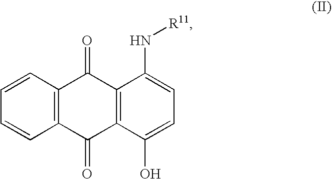

where
R¹¹ represents C₁-C₁₂-alkyl, which may be C₁-C₁₈-alkoxy, halogen or cyano substituted, cyclopentyl, cyclohexyl or a radical of the formula (IV)

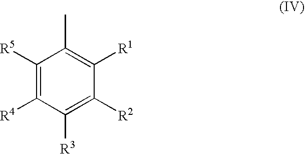

where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents optionally substituted C₆-C₁₀-aryl or C₁-C₄-alkyl and possible substituents are C₁-C₄-alkyl, hydroxyl, halogen, C₁-C₄-alkoxy or C₆-C₁₀-aryloxy.

N,N′-Disubstituted 1,4-diaminoanthraquinones are preferably those of the formula (III)

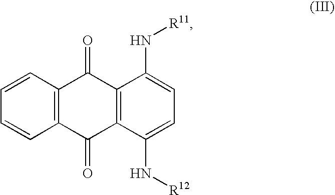

where
R¹¹ and R¹² independently represent C₁-C₁₂-alkyl, which may be C₁-C₁₈-alkoxy, halogen or cyano substituted, cyclopentyl, cyclohexyl or a radical of the formula (IV)

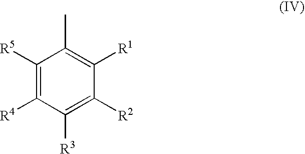

where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents optionally substituted C₆-C₁₀-aryl or C₁-C₄-alkyl and possible substituents are C₁-C₄-alkyl, hydroxyl, halogen, C₁-C₄-alkoxy or C₆-C₁₀-aryloxy.

Preferably, R¹¹ and R¹² are the same in the formula (III).

It is similarly preferable for R¹¹ and R¹² not to be the same in the formula (III). Then, it is particularly preferable for R¹¹ to represent an optionally substituted C₁-C₁₂-alkyl radical and R¹² a radical of the formula (IV). It is likewise preferable in this case for R¹¹ and R¹² both to represent a radical of the formula (IV) although the two radicals of the formula (IV) are not the same, i.e. they differ in at least one R¹ to R⁵ substituent.

It is preferable for R¹¹ and R¹² in the formulae (II) and (III) to each represent a radical of the formula (IV).

Preferably, in the formulae (II) and (III)

### R¹, R³ and R⁵ independently represent hydrogen or C₁- to C₄-alkyl and

### R² and R⁴ each represent hydrogen.

It is particularly preferable for at least one of R¹, R³ and R⁵ to represent methyl or ethyl in the formulae (II) and (III).

It is likewise particularly preferable for R¹ and R⁵ to independently represent methyl or ethyl in the formulae (II) and (III).

It is very particularly preferable for R¹¹ and R¹² in the formulae (II) and (III) to each represent phenyl, o-tolyl, p-tolyl, p-tert-butylphenyl, 2,6-dimethylphenyl, 2,4-dimethylphenyl, 3,5-dimethylphenyl, 2-ethyl-6-methylphenyl, 2,6-diethyl-4-methylphenyl, 2,4,6-trimethylphenyl, p-acetaminophenyl.

The process of the invention is particularly advantageous for preparing N,N′-disubstituted 1,4-diaminoanthraquinones of the formula (III), in particular those wherein R¹ and/or R⁵ do not represent hydrogen.

The process of the invention can also be used to convert N-substituted 1-amino-4-hydroxy-anthraquinones of the formula (II) into N,N′-disubstituted 1,4-diaminoanthraquinones of the formula (III). In such a case, R¹¹ and R¹² are then preferably different in the formula (III). The dyes of the formula (II) are then preferably reacted with an amine of the formula R¹²—NH₂ in the presence of a boric ester.

Useful amines for the process of the invention include in particular aliphatic, cycloaliphatic and aromatic amines with or without substituents. Aliphatic amines for example can be saturated, unsaturated, branched or straight chain.

Preferred aliphatic amines are C₁-C₁₂-alkylamines with or without C₁-C₁₈-alkoxy, halogen or cyano substitution.

Particularly preferred aliphatic amines are for example those of the following formulae:

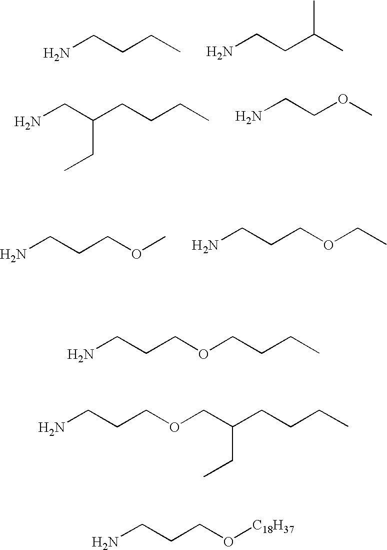

Cycloaliphatic amines are for example cyclopentylamine and cyclohexylamine.

Aromatic amines are in particular primary aromatic amines, very particularly those of the following formula (I):

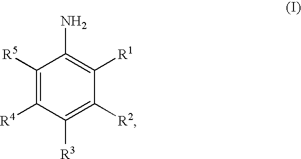

where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents optionally substituted C₆-C₁₀-aryl or C₁-C₄-alkyl and possible substituents are C₁-C₄-alkyl, hydroxyl, halogen, C₁-C₄-alkoxy or C₆-C₁₀-aryloxy.

Preferably,
R¹, R³ and R⁵ independently represent hydrogen or C₁-C₄-alkyl and
R² and R⁴ each represent hydrogen.

It is particularly preferable for at least one of R¹, R³ and R⁵ to represent methyl or ethyl. It is likewise particularly preferable for R¹ and R⁵ to independently represent methyl or ethyl.

Very particularly preferred aromatic amines are aniline, o-toluedine, p-toluedine, p-tert-butylaniline, 2,6-dimethylaniline, 2,4-dimethylaniline, 3,5-dimethylaniline, 2-ethyl-6-methyl-aniline, 2,6-diethyl-4-methylaniline, 2,4,6-trimethylaniline, p-acetanilide.

The process of the invention utilizes 1,4-dihydroxyanthraquinone (quinizarin) in a mixture with its leuco form, 2,3-dihydro-1,4-dihydroxyanthraquinone (leucoquinizarin), the leuco compound preferably being used in an amount of 1% to 90% by weight, preferably 1% to 50% by weight, more preferably 1% to 30% by weight, even more preferably 2% to 20% by weight and most preferably 3% to 10% by weight, based on the sum total of quinizarin and leucoquinizarin. Similarly, the preparation of N,N′-disubstituted 1,4-diaminoanthraquinones of the formula (III) where at least one of R¹ and R⁵ does not represent hydrogen may advantageously utilize an amount of leucoquinizarin ≦30% by weight and preferably ≦20% by weight, based on the sum total of quinizarin and leucoquinizarin.

The mixture of quinizarin and leucoquinizarin may for example be formed in situ from quinizarin by addition of reducing agents such as zinc dust or sodium dithionite. But quinizarin and leucoquinizarin can also be prepared separately and be used mixed in the process of the invention. There is further a particularly advantageous version wherein the leucoquinizarin is added to the reaction mixture, in particular to the hot and very particularly at least 50° C. hot reaction mixture, the leucoquinizarin advantageously being added as a solution in the solvent or solvent mixture used.

The ratio of amine to anthraquinone compound, i.e. the total amount of quinizarin and leucoquinizarin, is preferably decided according to whether N-substituted 1-amino-4-hydroxy-anthraquinones or N,N′-disubstituted 1,4-diaminoanthraquinones are to be prepared. When N-substituted 1-amino-4-hydroxyanthraquinones are to be prepared, the ratio is 1.0 to 1.5 mol equivalents, preferably 1.02 to 1.4 mol equivalents and more preferably 1.04 to 1.3 mol equivalents; when N,N′-disubstituted 1,4-diaminoanthraquinones are to be prepared, the ratio is 2.0 to 4.0 mol equivalents, preferably 2.1 to 3.0 mol equivalents and more preferably 2.2 to 2.5 mol equivalents. When in the latter case the amine is also used as a solvent, the ratio is for example 2.5 to 10.0 mol equivalents, preferably 4.0 to 8.0 mol equivalents and more preferably 5.0 to 7.0 mol equivalents.

Useful boric esters are those of C₁-C₆-alkanols and C₃-C₆-cycloalkanols and also of benzyl alcohol. Preference is given to boric esters whose corresponding alcohol has an atmospheric pressure boiling point of below 120° C., more preferably of below 100° C. and most preferably of below 80° C.

Preferred boric esters are those of optionally branched C₁-C₄-alkanols. Examples thereof are trimethyl borate, triethyl borate, tri-n-propyl borate, tri-1-propyl borate, tri-n-butyl borate, tri-s-butyl borate, tri-1-butyl borate.

Triethyl borate is particularly preferred. Trimethyl borate is very particularly preferred.

The ratio of boric ester to anthraquinone compound, i.e. the total amount of quinizarin and leucoquinizarin, is preferably in the range from 0.01 to 2.0 mol equivalents, more preferably in the range from 0.03 to 1.5 mol equivalents and even more preferably in the range from 0.05 to 1.3 mol equivalents. When N-substituted 1-amino-4-hydroxyanthraquinones of the formula (II) are to be prepared, it is generally sufficient to use a boric ester to anthraquinone compound ratio ≦0.2 and preferably ≦0.1 mol equivalent. When N,N′-disubstituted 1,4-diaminoanthraquinones of the formula (III) are to be prepared, it is generally advisable to apply a boric ester to anthraquinone compound ratio of in the range from 0.3 to 1.0 and advantageously of 0.5 to 0.8 mol equivalent.

The boric ester can be added to the reaction mixture before, at the same time as or after the amine. When the boric ester is added before the amine, the reaction of the boric ester with the quinizarin and/or leucoquinizarin and if appropriate with the hydroxy carboxylic acid can advantageously take place first. This reaction can take place at a temperature of 40 to 140° C., preferably 60 to 120° C. and more preferably 70 to 100° C. Advantageously, the alcohol released from the boric ester is distilled off in the process.

The process can be carried out in the presence of a hydroxy carboxylic acid. The process can also be carried out without the presence of a hydroxy carboxylic acid. Advantageously, the process is carried out in the presence of a hydroxy carboxylic acid. Useful hydroxy carboxylic acids are preferably aliphatic or aromatic. In one particular embodiment, the aliphatic hydroxy carboxylic acids bear the hydroxyl group and the carboxyl group on the same carbon atom. In another particular embodiment, the aromatic hydroxy carboxylic acids bear the hydroxyl group and the carboxyl group on two immediately adjacent aromatic carbon atoms.

Preferred aliphatic hydroxy carboxylic acids are particularly those having 2 to 7 carbon atoms. Examples thereof are hydroxyacetic acid, lactic acid, maleic acid, tartaric acid, citric acid, 2,2-bis(hydroxymethyl)propionic acid and galactonic acid. Hydroxyacetic acid and lactic acid are particularly preferred.

Useful aromatic hydroxy carboxylic acids are particularly o-hydroxy carboxylic acids of benzene and of naphthalene. Preference is given to salicylic acid and its derivatives, particularly methyl-, fluorine-, chlorine-, bromine-, hydroxyl-, cyano-, HOOC— or nitro-substituted derivatives. Examples are salicylic acid, 2,5-dihydroxy-1,4-benzenedicarboxylic acid, 2-naphthol-3-carboxylic acid.

The ratio of hydroxy carboxylic acid to anthraquinone compound, i.e. the total amount of quinizarin and leucoquinizarin, is preferably in the range from 0 to 2.0 mol equivalents, more preferably in the range from 0 to 1.0 mol equivalent, even more preferably in the range from 0.1 to 0.8 mol equivalent and most preferably in the range from 0.2 to 0.6 mol equivalent. The process of the invention can also be carried out in the presence of more than one hydroxy carboxylic acid. In that case, the stated amounts are based on the total mixture of these hydroxy carboxylic acids.

The process is carried out in a solvent, if appropriate. The amine used, in particular the amine of the formula (I), can itself serve as solvent. However, it is also possible to use other solvents. Useful other solvents include for example aliphatic alcohols such as n-butanol, 2-methyl-1-propanol, 2-butanol, i-amyl alcohol, optionally substituted aromatics such as dichlorobenzene, trichlorobenzene, toluene and xylene and also water-miscible polar solvents. Such water-miscible polar solvents include for example butyrolactone, N-methylpyrrolidone, caprolactam. It is also possible to use mixtures of such solvents. In this case it is preferable for example to use a mixture of a water-miscible polar solvent and a second solvent that has only limited solubility in water and advantageously forms an azeotrope with water, an example being a mixture of N-methylpyrrolidone and n-butanol. However, mixtures with water can also be used, an example being n-butanol and water. The amount of solvent is advantageously chosen as small as possible, provided sufficient stirring is still possible after the reaction has ended in particular.

When alcohols or mixtures of alcohols with water or other solvents are used, it may be advantageous to use the boric ester of the same alcohol, for example butanol and butyl borate. But it may also be advantageous, for example when using comparatively high-boiling alcohols as solvent or solvent component, to use a boric ester whose alcohol component has a very low boiling point, for example amyl alcohol and trimethyl borate.

The process is preferably carried out at a temperature of 60 to 200° C., advantageously of 80 to 160° C. and particularly advantageously of 90 to 150° C. The alcohol present in the boric ester can be distilled off in the process. The water of reaction can be distilled off together with this alcohol or else subsequently. However, it can also be advantageous, in particular in the preparation of N-substituted 1-amino-4-hydroxyanthraquinones, not to distil off the water of reaction and possibly the alcohol as well. The formation of the N,N′-disubstituted 1,4-diamino-anthraquinones, which are unwanted in this case, can be reduced in this way. For instance, the reaction can be conducted such that 1% to 20% by weight, preferably 1% to 10% by weight and more preferably 2% to 3% by weight of water is present in the reaction mixture at the end of the reaction.

After the reaction has ended, the reaction mixture is preferably cooled down. To oxidize any leuco compounds present, air can be passed through the reaction medium. To improve this oxidation, it can also be advantageous for boric and/or hydroxy carboxylic esters of the product dyes or their leuco forms to be cleaved and, if appropriate, oxidized by addition of alkali, for example sodium hydroxide or potassium hydroxide. However, the oxidation can also be carried out with other oxidizing agents apart from oxygen. The precipitation of the substituted aminoanthraquinones can be improved for example by addition of an alcohol, for example methanol, ethanol, propanol, butanol, or of water or of alcohol mixtures or of mixtures of alcohols and water. This addition of an alcohol can take place at room temperature to 160° C., preferably 50° C. to 140° C., advantageously under superatmospheric pressure in the case of temperatures above the boiling point of the alcohol. The substituted aminoanthraquinones are filtered off and washed with the said alcohols or a mixture of the solvent used in the reaction and the said alcohols. A wash with water generally follows. Finally, the dyes are dried.

The process of the invention is notable for excellent space-time yield, in particular due to saving of reaction time. The quality of the dyes is at least equivalent to that obtainable in previous processes. The process of the invention also leads to shorter reaction times and to the formation of fewer by-products. The use of the process of the invention also leads to a lower tendency to foam. This reduced tendency to foam is particularly useful when the amine is also used as a solvent.

The dyes prepared by the process of the invention are particularly useful for mass coloration of plastics, alone or mixed with other dyes.

The dyes prepared by the process of the invention are likewise particularly useful for dyeing synthetic fibres, alone or mixed with other dyes. They are advantageously used in dispersed form for that purpose.

The dyes are preferably used in amounts of 0.0001% to 1% by weight, in particular 0.01% to 0.5% by weight, based on the plastic or the synthetic fibres.

### EXAMPLES

### Example 1

20.0 g of quinizarin, 23.0 g of dihydroquinizarin (contains 1.5 g of quinizarin), 11.35 g of trimethyl borate were introduced into 153 g of 2,4,6-trimethylaniline under nitrogen. After heating to 50° C., 7.84 g of 90% by weight lactic acid were added. The mixture was heated to 145° C. within just 1 h without foaming, the resulting methanol and water being distilled off. The mixture was stirred at that temperature for 3.5 h and checked for complete conversion via thin layer chromatogram. This was followed by cooling to 100° C. and the introduction of air for 3 h. After cooling to 70° C., 17.35 g of potassium hydroxide powder were added and after heating to 100° C. air was again passed in for 3 h. This was followed by cooling to 80° C. 220 ml of methanol were added dropwise. Finally, the suspension was filtered off with suction at 60° C., washed with 220 ml of hot methanol (at 60° C.) and subsequently with 11 of hot water (at 80° C.) in portions. This was followed by vacuum drying at 50° C. to obtain 70.8 g (83.5% of theory) of a blue crystalline powder of the formula

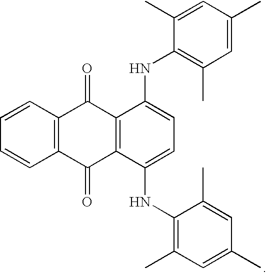

Heating time: 1 h
Condensation time: 3.5 h

### Example 2

30.7 g of quinizarin, 12.3 g of dihydroquinizarin (contains 0.8 g of quinizarin), 11.35 g of trimethyl borate were introduced into 125 g of 2,4,6-trimethylaniline under nitrogen. After heating to 50° C., 7.84 g of 90% by weight lactic acid were added. The mixture was heated to 145° C. within just 1 h without foaming, the resulting methanol and water being distilled off. The mixture was stirred at that temperature for 3.5 h and checked for complete conversion via thin layer chromatogram. This was followed by cooling to 100° C. and the introduction of air for 3 h. After cooling to 70° C., 17.35 g of potassium hydroxide powder were added and after heating to 100° C. air was again passed in for 3 h. This was followed by cooling to 80° C. 160 ml of methanol were added dropwise. Finally, the suspension was filtered off with suction at 60° C., washed with 220 ml of hot methanol (at 60° C.) and subsequently with 11 of hot water (at 80° C.) in portions. This was followed by vacuum drying at 50° C. to obtain 70.4 g (83.0% of theory) of a blue crystalline powder of the formula of Example 1.

Heating time: 1 h
Condensation time: 3.5 h

### Example 2a

15.9 g of triethyl borate were used instead of trimethyl borate. Heating time, condensation time and yield were unchanged.

### Example 3

Example 2 was repeated except that 8.51 g of trimethyl borate and 5.88 g of 90% by weight lactic used were used. This gave 70.5 g (83.1% of theory) of a blue crystalline powder of the formula of Example 1. The heating phase was exactly the same length.

Heating time: 1 h
Condensation time: 3.5 h

### Example 3a

5.52 g of hydroxyacetic acid were used instead of lactic acid. Heating time, condensation time and yield were unchanged.

### Example 3b

10.0 g of salicylic acid were used instead of lactic acid. Heating time, condensation time and yield were unchanged.

### Example 4

### Comparative Example, Similar to Example 4 of EP 751116, But with Lactic Acid Instead of Hydroxyacetic Acid

20.0 g of quinizarin, 23.0 g of dihydroquinizarin (contains 1.5 g of quinizarin), 5.84 g of boric acid were introduced into 153 g of 2,4,6-trimethylaniline under nitrogen. After heating to 50° C., 7.84 g of 90% by weight lactic acid were added. The mixture was heated to 115° C. over 1 h and maintained at 115° C. for 4 h. If this time is not adhered to, severe foaming will take place in the course of continued heating and can lead to overfoaming into the distillation receiver. This is followed by heating to 145° C. over 2 h and stirring at 145° C. for 6 h, during which resulting water was distilled off. Completeness of reaction was checked via a thin layer chromatogram. This was followed by cooling to 100° C. and air introduction for 3 h. After cooling to 70° C., 17.35 g of potassium hydroxide powder were added and after heating to 100° C. again air introduced for 3 h. The mixture was cooled to 80° C. 220 ml of methanol were added dropwise. Finally, the suspension was filtered off with suction at 60° C., washed with 220 ml of hot methanol (at 60° C.) and then with 11 of hot water (at 80° C.) in portions. Vacuum drying was carried out at 50° C. to obtain 71.1 g (83.9% of theory) of a blue crystalline powder of the formula of Example 1.

Heating time: 7 h
Condensation time: 6 h

It needed 7 hours to reach the ultimate reaction temperature because of the foaming. In Examples 1 to 3 this took just one hour. In addition, the same yields as in Examples 1 to 3 took 6 hours to achieve instead of 3.5 hours. In addition, in Examples 2 and 3 the amount of dihydroquinizarin and boric ester used was distinctly reducible without disadvantage.

### Example 5

67.8 g of quinizarin, 4.27 g of dihydroquinizarin (contains 0.28 g of quinizarin), 39.7 g of p-toluedine, 2.52 g of trimethyl borate and 7.50 g of 90% by weight lactic acid were introduced into 120 ml of γ-butyrolactone under nitrogen. The temperature was raised to 100° C. over 1 h and the mixture was maintained at 100° C. for 12 h, the degree of conversion being policed via thin layer chromatography. The residual level of quinizarin had dropped to below 10% after just 8 h. At that point, the mixture was cooled down to room temperature, filtered off with suction, and the filter residue was washed with 250 ml of hot methanol (at 60° C.) and 11 of hot water (at 80° C.) in portions. Drying at 50° C. under reduced pressure left 91.46 g (92.6% of theory) of a violet crystalline powder of the formula

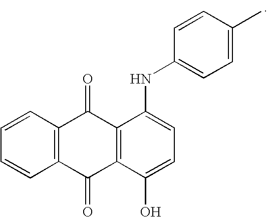

The product contained 5.31% of the compound of the formula

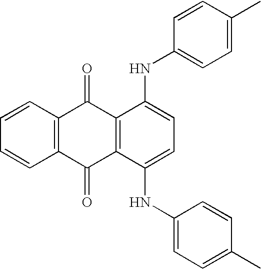

and also 0.93% of quinizarin.
Heating time: 1 h
Condensation time: 12 h

### Example 6

### Comparative

67.8 g of quinizarin, 4.27 g of dihydroquinizarin (contains 0.28 g of quinizarin), 39.7 g of p-toluedine, 1.00 g of boric acid and 7.50 g of 90% by weight lactic acid were introduced into 100 ml of γ-butyrolactone under nitrogen. The mixture was heated to 100° C. over 1 h and maintained at 100° C. for 8 h. Since a thin layer chromatogram showed that about 30% of the quinizarin had still not reacted, 20 g of p-toluedine were added and stirring was continued at 100° C. for 6 h: remaining quinizarin about 20%. This was followed by heating to 125° C. and stirring at that temperature for a further 4 h. Since the residual level of quinizarin had now dropped to below 10%, the mixture was cooled to room temperature, and filtered with suction, and the filter residue was washed with 250 ml of hot methanol (at 60° C.) and 11 of hot water (at 80° C.) in portions. Drying at 50° C. under reduced pressure left 90.11 g (91.2% of theory) of a violet crystalline powder of the formula of Example 5.

The product contained 6.98% of the compound of the formula

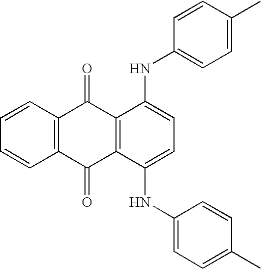

and also 1.22% of quinizarin.
Heating time: 1 h
Condensation time: 18 h

### Example 7

22.3 g of quinizarin, 23.6 g of dihydroquinizarin (contains 0.54 g of quinizarin), 12.8 g of trimethyl borate and 6.05 g of 90% by weight lactic acid were introduced into 172.4 g of 2-methyl-6-ethylaniline under nitrogen. The mixture was heated to 115° C. over 1 h, in the course of which the resulting methanol was distilled off. Without delay, the temperature was then raised to 145° C. over 1 h, so that the foam-free heating phase took 2 hours, and the mixture was stirred at 145° C. for 8 h, during which resulting water was distilled off. Completeness of reaction was checked via a thin layer chromatogram. The mixture was then cooled down to 125° C. and air was passed into it for 3 h. After cooling to 70° C., 24.4 g of potassium hydroxide powder were added and air was again passed into it at 70° C. for 3 h. 360 ml of methanol were added dropwise in the course of 2 h at 70° C., followed by 1 h of stirring under gentle boiling. Finally, the suspension was cooled down to room temperature, filtered off with suction, washed with 250 ml of cold methanol and then with 11 of hot water (at 80° C.) in portions. Vacuum drying at 80° C. left 67.0 g (74.7% of theory) of a blue crystalline powder of the formula

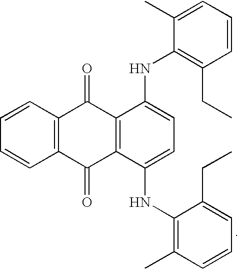

Heating time: 2 h
Condensation time: 8 h

### Example 8

Example 7 was repeated except that 33.1 g of quinizarin and 12.8 g of dihydroquinizarin (contains 0.27 g of quinizarin) were used. This gave 67.2 g (74.0% of theory) of a blue crystalline powder of the formula of Example 7.

Heating time: 2 h
Condensation time: 8 h

### Example 9

### Comparative

22.3 g of quinizarin, 23.6 g of dihydroquinizarin (contains 0.54 g of quinizarin), 7.6 g of boric acid and 6.05 g of 90% by weight lactic acid were introduced into 172.4 g of 2-methyl-6-ethylaniline under nitrogen. The mixture was heated to 115° C. over 1 h. It was stirred at 115° C. for 3.5 h. It was then heated to 145° C. over 2.5 h, meaning that the heating phase took 7 hours with the continuous production during this period of foam, but which remained manageable. This was followed by stirring at 145° C. for 6 h, during which resulting water was distilled off. Completeness of reaction was checked via a thin layer chromatogram. The mixture was then cooled down to 125° C. and air was passed into it for 3 h. After cooling to 70° C., 24.4 g of potassium hydroxide powder were added and air was again passed into it at 70° C. for 3 h. 360 ml of methanol were added dropwise in the course of 2 h at 70° C., followed by 1 h of stirring under gentle boiling. Finally, the suspension was cooled down to room temperature, filtered off with suction, washed with 250 ml of cold methanol and then with 11 of hot water (at 80° C.) in portions. Vacuum drying at 80° C. left 68.4 g (76.3% of theory) of a blue crystalline powder of the formula of Example 7.

Heating time: 7 h
Condensation time: 6 h

### Example 10

### Comparative Example, Corresponding to Example 6 of EP 751116

40.5 g of quinizarin, 40.5 g of dihydroquinizarin, 12.8 g of boric acid and 14.4 g of 90% by weight lactic acid were introduced into 280 g of 2-methyl-6-ethylaniline under nitrogen. To avoid foaming, the stirred mixture was heated up as follows: over 1 h to 115° C., holding at 115° C. for 3.5 h, heating to 145° C. over 2.5 h. This was followed by stirring at 145° C. for 12 h, during which resulting water was distilled off. Completeness of reaction was checked via a thin layer chromatogram. This was followed by cooling to 90° C., addition of 50 g of KOH and introduction of air for 3 h. The mixture was then cooled down to 70° C. and admixed with 450 ml of methanol. After cooling to room temperature, the blue dye was filtered off, washed with 300 ml of methanol and then with 11 of water and finally vacuum dried at 80° C. to leave 125.2 g (81.7% of theory) of the dye of the formula of Example 7.

Heating time: 7 h
Condensation time: 12 h

### Example 11

20.35 g of quinizarin, 20.38 g of dihydroquinizarin (contains 0.47 g of quinizarin), 10.8 g of trimethyl borate and 8.71 g of 90% by weight lactic acid were introduced into 159.7 g of 2,6-diethyl-4-methylaniline under nitrogen. The mixture was heated to 115° C. over 1 h, in the course of which the resulting methanol was distilled off. Without delay, the temperature was then raised to 145° C. over 2.5 h, and the mixture was stirred at 145° C. for 8 h, during which resulting water was distilled off. Completeness of reaction was checked via a thin layer chromatogram. The mixture was then cooled down to 125° C. and air was passed into it for 3 h. After cooling to 80° C., 20.6 g of potassium hydroxide powder were added and air was again passed into it at 80° C. for 4 h. 290 ml of methanol were added dropwise in the course of 2 h at 70° C., followed by 1 h of stirring under gentle boiling. Finally, the suspension was cooled down to room temperature, filtered off with suction, washed with 200 ml of cold methanol and then with 11 of hot water (at 80° C.) in portions. Vacuum drying at 80° C. left 72.9 g (82.0% of theory) of a blue crystalline powder of the formula

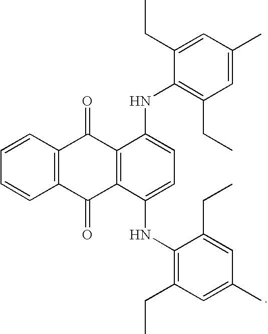

Heating time: 3.5 h
Condensation time: 8 h

### Example 12

22.3 g of quinizarin, 23.9 g of dihydroquinizarin (contains 0.98 g of quinizarin), 28.8 g of tributyl borate and 6.44 g of 85% by weight lactic acid were introduced into 172.4 g of 2-methyl-6-ethylaniline under nitrogen. The mixture was heated to 115° C. over 1 h and immediately thereafter to 145° C. over 1 h, so that the foam-free heating phase took 2 hours. All the while the resulting butanol was distilled off. The mixture was stirred at 145° C. for 8 h, during which resulting water was distilled off. Completeness of reaction was checked via a thin layer chromatogram. The mixture was then cooled down to 125° C. and air was passed into it for 3 h. 360 ml of methanol were added dropwise at 70° C. over 2 h, followed by 1 h of stirring under gentle boiling. Finally, the suspension was cooled down to room temperature, filtered off with suction, washed with 250 ml of cold methanol and then with 11 of hot water (at 80° C.) in portions. Vacuum drying at 80° C. left 67.5 g (75.3% of theory) of a blue crystalline powder of the formula of Example 7.

Heating time: 2 h
Condensation time: 8 h

1. A Process for preparing substituted aminoanthraquinones by reacting 1,4-di-hydroxyanthraquinone with amines in the presence of dihydro-1,4-dihydroxyanthraquinone and a boric ester.

2. The Process according to claim 1, wherein the amines comprise aliphatic, cycloaliphatic or aromatic amines with or without substituents.

3. The Process according to claim 1, wherein the boric ester is derived from C₁-C₆-alkanoles and C₃-C₆-cycloalkanoles and also from benzyl alcohol.

4. The Process according to claim 1, wherein the boric ester is derived from C₁-C₆-alkanoles and C₃-C₆-cycloalkanoles and also from benzyl alcohol and the alcohol corresponding to the boric ester has an atmospheric pressure boiling point of below 120° C.

5. The Process according to claim 1, wherein the boric ester is derived from C₁-C₆-alkanoles and C₃-C₆-cycloalkanoles and also from benzyl alcohol and the boric ester comprises trimethyl borate, triethyl borate, tri-n-propyl borate, tri-1-propyl borate, tri-n-butyl borate, tri-s-butyl borate, tri-1-butyl borate.

6. The Process according to claim 1, wherein the amine is selected from the group of the aliphatic amines of the following formulae: 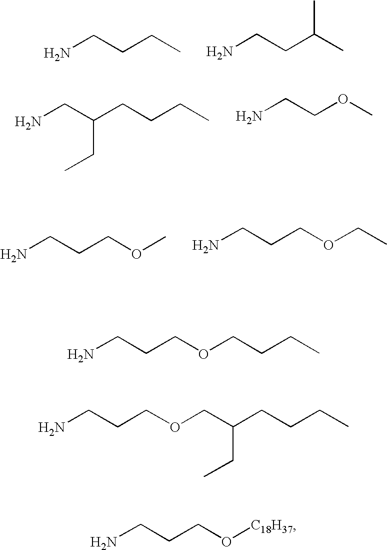
the cycloaliphatic amines cyclopentylamine and cyclohexylamine and
the aromatic amines from the group of the primary aromatic amines of the following formula (I): 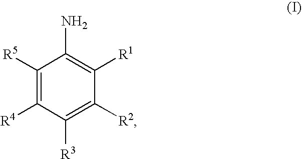
where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents unsubstituted or substituted C₆-C₁₀-aryl or C₁-C₄-alkyl wherein possible substituents are C₁-C₄-alkyl, hydroxyl, halogen, C₁-C₄-alkoxy or C₆-C₁₀-aryloxy.

7. The Process according to claim 6, wherein aromatic amines conform to the following formula (I): 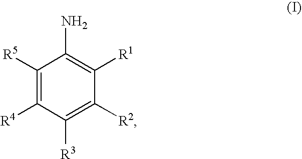
where
R¹, R³ and R⁵ independently represent hydrogen or C₁-C₄-alkyl and
R² and R⁴ each represent hydrogen.

8. The Process according to claim 1, wherein the substituted aminoanthraquinones comprise those of the formula (II) 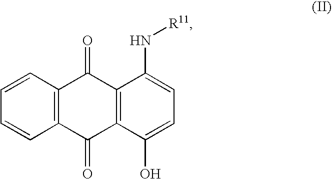
where
R¹¹ represents C₁-C₁₂-alkyl, which is unsubstituted or substituted by C₁-C₁₈-alkoxy, halogen or cyano, cyclopentyl, cyclohexyl or a radical of the formula (IV) 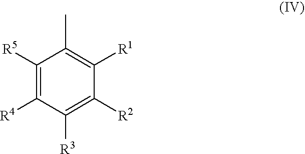
where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents unsubstituted or substituted C₆-C₁₀-aryl or C₁-C₄-alkyl and possible substituents are C₁-C₄-alkyl, hydroxyl, halogen, C₁-C₄-alkoxy or C₆-C₁₀-aryloxy
or those of the formula (III) 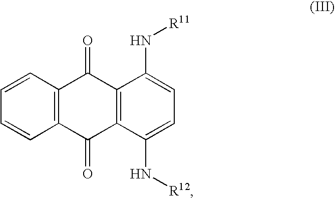
where
R¹¹ and R¹² independently represent C₁-C₁₂-alkyl, which is unsubstituted or substituted by C₁-C₁₈-alkoxy, halogen or cyano, cyclopentyl, cyclohexyl or a radical of the formula (IV) 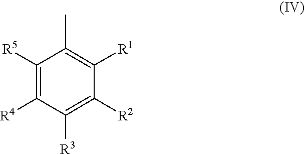
where
R¹ to R⁵ independently represent hydrogen, C₁-C₁₂-alkyl, halogen, C₁-C₄-alkoxy, C₆-C₁₀-aryloxy or C₁-C₄-alkanoylamino and
R² can additionally represent SO₂NH—R⁶, where R⁶ represents unsubstituted or substituted C₆-C₁₀-aryl or C₁-C₄-alkyl and possible substituents are C₁-C₄-alkyl, hydroxyl, halogen, C₁-C₄-alkoxy or C₆-C₁₀-aryloxy.

9. The Process according to claim 8, wherein in the formulae (II) and (III)
R¹¹ and R¹² each represent phenyl, o-tolyl, p-tolyl, p-tert-butylphenyl, 2,6-dimethylphenyl, 2,4-dimethylphenyl, 3,5-dimethylphenyl, 2-ethyl-6-methylphenyl, 2,6-diethyl-4-methylphenyl, 2,4,6-trimethylphenyl, p-acetaminophenyl.

10. The Process according to claim 1, wherein the ratio of boric ester to anthraquinone compound, i.e. the total amount of quinizarin and leucoquinizarin, is in the range from 0.01 to 2.0 mol equivalents, preferably in the range from 0.03 to 1.5 and more preferably 0.05 to 1.3 mol equivalents.

11. The Process according to claim 1, wherein it is carried out in the presence of a hydroxy carboxylic acid.

12. The Process according to claim 1, wherein it is carried out in the presence of a hydroxy carboxylic acid where by hydroxyacetic acid, lactic acid, maleic acid, tartaric acid, citric acid, 2,2-bis(hydroxymethyl)propionic acid, galactonic acid, salicylic acid, 2,5-dihydroxy-1,4-benzenedicarboxylic acid or 2-naphthol-3-carboxylic acid are used as hydroxy carboxylic acids.

13. The Process according to claim 1, wherein the reaction is carried out at a temperature of 60 to 200° C.

14. A Process for mass coloration of plastics or for dyeing synthetic fibres, wherein the dyes prepared by the process according to claim 1 are used.
